(19) United States
(12) Patent Application Publication
(10) Pub. No.: US 2026/0220689 A1
(43) Pub. Date: Jul. 30, 2026

(54) PRODUCT RECOMMENDATION DEVICE, PRODUCT RECOMMENDATION METHOD, AND RECORDING MEDIUM

(71) Applicant: NEC Corporation, Tokyo (JP)

(72) Inventor: Kouichi KIMURA, Tokyo (JP)

(73) Assignee: NEC Corporation, Tokyo (JP)

(21) Appl. No.: 19/143,516

(22) PCT Filed: Mar. 15, 2023
(86) PCT No.: PCT/JP2023/010087

§ 371 Date: Jun. 26, 2025

(51) Int. Cl. G06Q 30/0601; G06V 40/16

(52) U.S. Cl. CPC G06Q 30/06311; G06Q 30/06312; G06V 40/168

(57) ABSTRACT

This product recommendation device includes: an acquisition means for acquiring facial information indicating facial features of an intended user; an identification means for identifying other pieces of facial information which are highly similar to the facial features indicated by the facial information; a generation means for generating product recommendation information for the intended user on the basis of history information about purchases of products by other users associated with the identified other pieces of facial information; and an output means for outputting the product recommendation information.

### TECHNICAL FIELD

The present disclosure relates to a product recommendation device, a product recommendation method, and a program.

### BACKGROUND ART

There is a technology for recommending a product that a customer wants to purchase, such as a product that matches the user's preference or a product that looks on the user, by using user information.

PTL 1 describes a technology for searching for an image with features similar to those in an image including a user's face, and recommending a product included in the image in which a person included in the similar image is shown. PTL 1 describes using, for example, an image posted on a social network service (SNS) as an image for determining a product to be recommended.

### CITATION LIST

### Patent Literature

PTL 1: JP 2022-093001 A

### SUMMARY OF INVENTION

### Technical Problem

However, in the technology described in PTL 1, it is necessary to identify a product from an image in which a person with a face similar to the user's is shown. It is generally difficult to identify a product used by a person from an image. In this manner, it may be difficult to identify a product to be recommended to the user.

An object of the present disclosure is to provide a technology for more easily recommending a product to a user.

### Solution to Problem

According to an aspect of the present disclosure, there is provided a product recommendation device including: an acquisition means for acquiring facial information indicating facial features of an intended user; an identification means for identifying other pieces of facial information having a high degree of similarity to the facial features indicated by the facial information; a generation means for generating product recommendation information for the intended user based on history information about purchases of products by other users associated with the identified other pieces of facial information; and an output means for outputting the product recommendation information.

According to another aspect of the present disclosure, there is provided a product recommendation method including causing a computer to: acquire facial information indicating facial features of an intended user; identify other pieces of facial information having a high degree of similarity to the facial features indicated by the facial information; generate product recommendation information for the intended user based on history information about purchases of products by other users associated with the identified other pieces of facial information; and output the product recommendation information.

According to still another aspect of the present disclosure, there is provided a product recommendation program that causes a computer to execute processing of: acquiring facial information indicating facial features of an intended user; identifying other pieces of facial information having a high degree of similarity to the facial features indicated by the facial information; generating product recommendation information for the intended user based on history information about purchases of products by other users associated with the identified other pieces of facial information; and outputting the product recommendation information.

The program may be stored in a non-transitory computer-readable recording medium.

### Advantageous Effects of Invention

An example of an effect of the present disclosure is that a product can be more easily recommended to a user.

### BRIEF DESCRIPTION OF DRAWINGS

FIG. 1 is a diagram illustrating a configuration of a system including a product recommendation device according to the present disclosure.

FIG. 2 is a block diagram illustrating a functional configuration of a product recommendation device according to the present disclosure.

FIG. 3 is a diagram illustrating an example of a display screen of product recommendation information.

FIG. 4 is a diagram illustrating another example of a display screen of product recommendation information.

FIG. 5 is a diagram illustrating still another example of a display screen of product recommendation information.

FIG. 6 is a diagram illustrating still another example of a display screen of product recommendation information.

FIG. 7 is a flowchart illustrating an operation of a product recommendation device according to the present disclosure.

FIG. 8 is a block diagram illustrating a functional configuration of a product recommendation device according to a modification example of the present disclosure.

FIG. 9 is a diagram illustrating a hardware configuration in which a product recommendation device according to the present disclosure is implemented by a computer and its peripheral devices.

### EXAMPLE EMBODIMENT

Hereinafter, example embodiments of the present disclosure will be described in detail with reference to the drawings.

### Example Embodiment

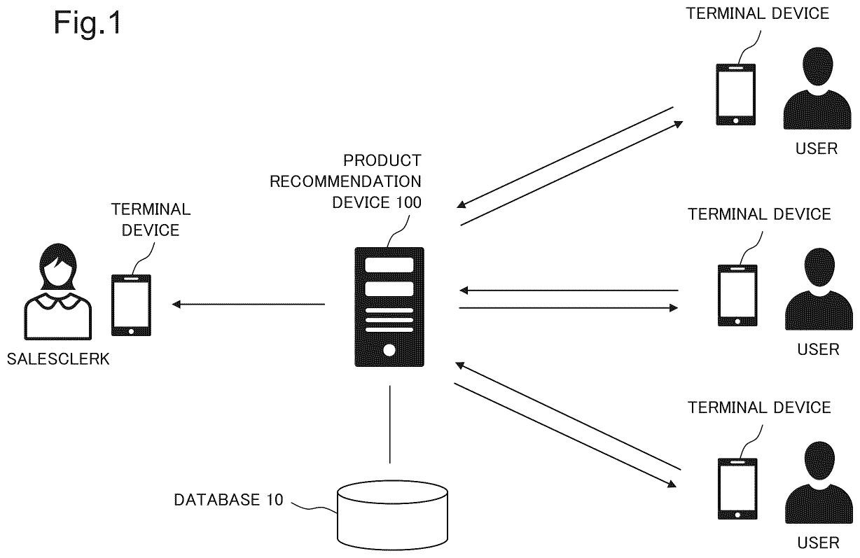

FIG. 1 is a diagram illustrating an example of a configuration of a system including a product recommendation device 100 according to the present disclosure. The product recommendation device 100 is a device that outputs product recommendation information to an intended user based on history information about purchases of products by other users associated with other pieces of facial information having a high degree of similarity to the facial features indicated by the facial information using the facial information indicating the facial features of the intended user. The product is, for example, a product to be worn on the body, such as cosmetics and fashion accessories, but is not limited thereto. It is estimated that persons with similar facial features look good in the same product. Therefore, the product recommendation device 100 can provide the product recommendation information with high appeal to the intended user by using the facial information indicating the facial features of the intended user. In the present disclosure, the intended user is a user who is a target of product recommendation. Other users are users other than the intended user. In the following description, the intended user and other users will be collectively referred to as a user.

In FIG. 1, the product recommendation device 100 is communicably connected to a terminal device and a database 10.

In FIG. 1, the terminal device is a terminal device used by the intended user or a salesclerk who provides customer service to the intended user. The terminal device includes at least a display unit. The display unit of the terminal device displays the product recommendation information output by the product recommendation device 100. The terminal device may include a camera.

In FIG. 1, the database 10 is a database that stores facial information of a user and history information about purchase of a product by a user. The database 10 is a database that stores the facial information of a user and the history information about purchase of a product by a user in association with each other for each user. The database 10 includes at least facial information of other users and history information.

The database 10 may be configured as two databases: a database that stores the facial information of the user and identification information in association with each other and a database that stores the history information about purchase of a product by a user and the identification information in association with each other. In this case, the facial information and the history information about purchase of a product are associated with each other using the identification information.

The database 10 may be provided inside the product recommendation device 100 or may be provided outside the product recommendation device 100.

Next, the configuration of the product recommendation device 100 according to the example embodiment will be described.

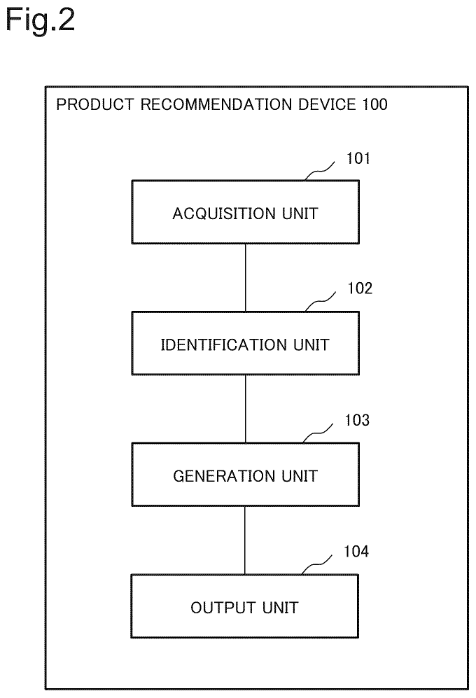

FIG. 2 is a block diagram illustrating the configuration of the product recommendation device 100 according to the example embodiment. Referring to FIG. 2, the product recommendation device 100 includes an acquisition unit 101, an identification unit 102, a generation unit 103, and an output unit 104.

Next, the configuration of the product recommendation device 100 according to the example embodiment will be described in detail.

In FIG. 2, the acquisition unit 101 is an example of an acquisition means for acquiring facial information indicating facial features of an intended user. For example, the acquisition unit 101 acquires the facial information of the intended user from the terminal device.

The facial information is information indicating the facial features of the user. The facial features are, for example, the shapes of facial parts such as eyes, nose, mouth, and eyebrows, the size of the facial parts, the positions of the facial parts, the positional relationships among the facial parts and between the facial parts and a facial contour, the facial contour, a skin tone, an eye color, an eyebrow color, a hairstyle, a hair color, and facial impression, and the like. The facial information indicating the facial features is, for example, a facial image.

The facial information indicating the facial features may be a feature amount indicating the facial features identified based on the facial image. In this case, the acquisition unit 101 may acquire the feature amount indicating the facial features from the terminal device. The acquisition unit 101 may detect the feature amount indicating the facial features from the facial image acquired from the terminal device.

For example, the acquisition unit 101 may acquire the facial information of the intended user associated in advance with the membership information of the intended user. The membership information is information about a user who is a member of a store or the like. In this case, the acquisition unit 101 acquires the membership information of the intended user from the terminal device, and refers to a membership information database to acquire the facial information associated with the membership information of the intended user. The membership information database is a database that stores member information of each member. The product recommendation device 100 is only required to be provided to be able to communicate internally or externally. The membership information database may be included in the database 10 described in FIG. 1.

The identification unit 102 is an example of an identification means for identifying other pieces of facial information having a high degree of similarity to the facial features indicated by the facial information. The identification unit 102 refers to the database 10 and identifies other pieces of facial information having a high degree of similarity to the facial features indicated by the facial information of the intended user among pieces of the facial information of the other users using a known method. For example, the identification unit 102 may identify other pieces of the facial information having a degree of similarity, equal to or greater than a predetermined degree of similarity, to the facial features indicated by the facial information of the intended user. The identification unit 102 may identify a plurality of pieces of other facial information. The identification unit 102 may identify a predetermined number of other pieces of the facial information having a high degree of similarity to the facial features indicated by the facial information of the intended user. More specifically, for example, the identification unit 102 may identify a predetermined number of other pieces of the facial information in descending order of the degree of similarity to the facial features indicated by the facial information of the intended user.

The generation unit 103 is an example of a generation means for generating product recommendation information for the intended user based on history information about purchases of products of other users associated with the identified other pieces of facial information. The generation unit 103 identifies the history information about purchases of products of other users associated with the other pieces of facial information identified by the identification unit 102 by referring to the history information database. The history information database is a database that stores history information of each user. The history information database is only required to be provided to be able to communicate with the product recommendation device 100 internally or externally. The generation unit 103 may identify the history information from the history information database in which the facial information and the history information are stored in association with each other. The generation unit 103 may identify the membership information associated with other pieces of facial information identified by the identification unit 102 from the membership information database in which the facial information and the membership information are stored in association with each other, and may identify the history information associated with the identified membership information from the database in which the history information and the membership information are stored in association with each other.

For example, in a case where a plurality of pieces of other facial information is identified by the identification unit 102, the generation unit 103 may identify history information of other users respectively related to the identified other pieces of facial information. The generation unit 103 generates product recommendation information that is information about a product to be recommended to the intended user based on the information about the product included in the identified history information.

The generation unit 103 may generate the product recommendation information in a specific product category. The generation unit 103 may extract information about a product related to the specific product category from pieces of the information about the products included in the identified history information, and generate product recommendation information.

The product category is obtained by categorizing the product into a purpose, a shape, a material, an application area, and the like. In a case where the product is cosmetics, examples of the product categories include categories divided by purpose, such as lipstick, eyeshadow, eyeliner, eyebrow pencil, and cheek powder and categories divided by an application area, such as lip makeup, eye makeup, eyebrow makeup, and cheek makeup. In a case where the product is clothing, examples of the product categories include tops, bottoms, and outerwear.

The specific product category may be designated by the intended user or the like. The specific product category may be determined based on the history information of the intended user. For example, the generation unit 103 may generate the product recommendation information in the specific product category designated through an input operation on the terminal device by the intended user or a salesclerk who provides customer service to the intended user. The product category designated at this time is a product category that the intended user desires to purchase. For example, the generation unit 103 may generate product recommendation information about a product category with high purchase frequency of the intended user from the history information of the intended user. The generation unit 103 may generate product recommendation information about a product category with low purchase frequency of the intended user. For example, the generation unit 103 may generate product recommendation information in a specific product category designated in advance, such as a product recommended by the store selling the products or by the manufacturer producing the products.

Here, the history information is history information about purchase of a product of the user. The history information is a purchase history indicating a history of a product purchased by the user. The purchase history may include a history of a purchase reservation of the product. The history information may include a customer service history which is information about details of the customer service provided by the salesclerk to the user. The customer service history may be information indicating a history of products used for customer service. Examples of the products used for customer service include a product tried by a user, a product in which a user is interested, a product that a user hesitates to purchase, and a product recommended to a user by a salesclerk.

The history information may be history information in a period such as recent several years or recent several months. This is because the lineup of products available for sale and market trends may change over time. The history information may be history information in the same month as the month in which product recommendation information is generated or history information in the same season as the season in which product recommendation information is generated. The season may be a predetermined period such as March to May in one year, or a period with similar climate. This is because the lineup of products available for sale may change depending on the season.

The product recommendation information is information about a product to be recommended to the intended user. The product recommendation information may include at least one of information indicating the type of product or information indicating features of the product as information about the product to be recommended to the intended user. The type of product may be a product series or a product identification number. The features of the product may be a color of the product and the like. In a case where the product is cosmetics, the features of the product may be, for example, the color of the product (hue, color saturation, color brightness, and the like), product texture (glossy or matte), a form (liquid or pressed powder), and the like. In a case where the product is clothing, the feature of the product may be, for example, a color of the product, a pattern of the product, a material of the product, or the like.

The generation unit 103 may generate information indicating products included in the history information associated with the identified other pieces of facial information as the product recommendation information for the intended user. For example, the generation unit 103 may generate information indicating products that frequently appear in the history information as the product recommendation information for the intended user. The product information included in the product recommendation information may include information indicating a plurality of products.

The generation unit 103 may generate information indicating a product that is currently being sold among the products included in the history information associated with the identified other pieces of facial information as the product recommendation information for the intended user. In this case, by referring to the product information database, the generation unit 103 may identify a product that is currently being sold among the products included in the history information associated with the identified other pieces of facial information.

Here, the product information database is a database that stores information about products currently being sold. The product information database is only required to be provided to be able to communicate with the product recommendation device 100 internally or externally. The product information database may be included in the database 10 of FIG. 1. The product information database is not particularly limited, but may be, for example, a database including only products that are currently being sold. In this case, the product not included in the product information database is a product that is not currently sold. Therefore, the generation unit 103 may identify the product included in the product information database among the products included in the history information associated with the identified other pieces of facial information as the product that is currently being sold. For example, the product information database includes information indicating the sales period of each product. In this case, the generation unit 103 may identify a product within the sales period at the time of performing the product recommendation in the product information database among the products included in the history information associated with the identified other pieces of facial information as the product that is currently being sold. The information indicating the sales period of the product may include information indicating a reservation period of the product. For example, the product information database may include information indicating the presence or absence of stock for each product. In this case, the generation unit 103 may identify a product that is in stock at the time of performing the product recommendation in the product information database among the products included in the history information associated with the identified other pieces of facial information as the product that is currently being sold.

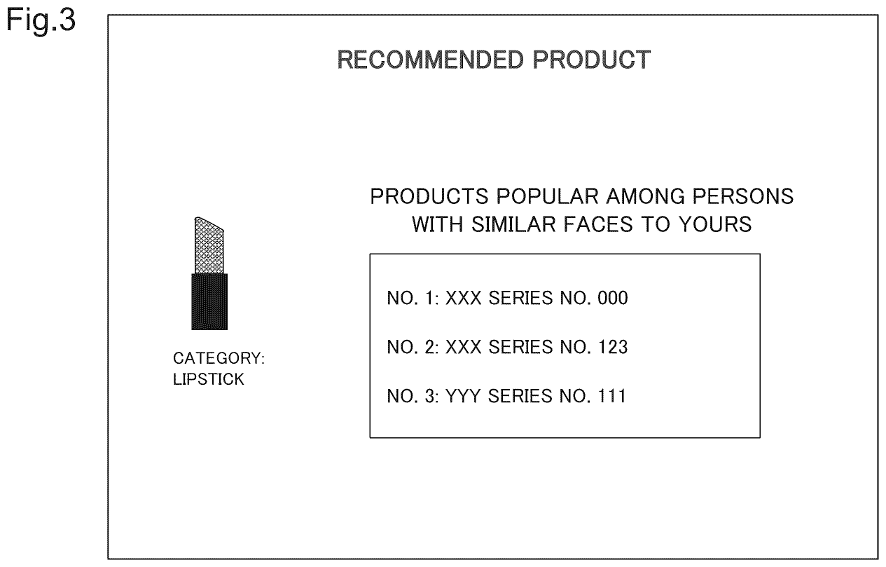

FIG. 3 is an example of the product recommendation information generated by the generation unit 103. In FIG. 3, the product recommendation information indicates three products: “XXX series No. 000”, “XXX series No. 123“, and ”YYY series No. 111”, which are the most frequently included among the products in the history information associated with the identified other pieces of facial information, as “products popular among persons with similar faces” for the intended user.

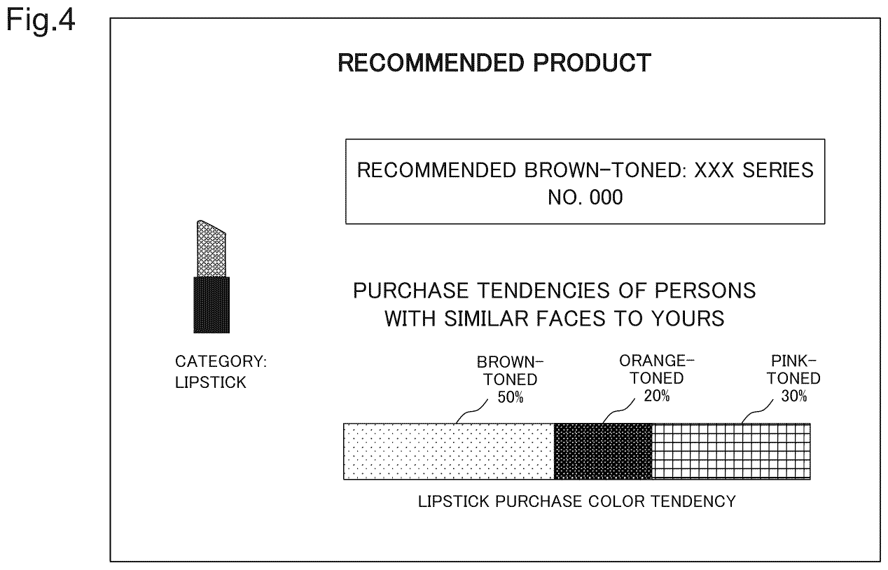

The generation unit 103 may generate information indicating purchase tendencies as the product recommendation information based on the information about products included in the history information associated with the identified other pieces of facial information. For example, the generation unit 103 may generate the proportion of product types among the products included in the identified history information or the proportion of the product features among the products included in the identified history information as the information indicating purchase tendencies. The proportion of product types among the products included in the identified history information may be the proportion at which a certain type of product is included in the products included in the identified history information. The proportion of the product features among the products included in the identified history information may be, for example, the proportion of the product colors among the products included in the identified history information. In a case where the product to be recommended is a lipstick, for example, the proportion of the product features may be the proportion of the lipstick shades among the purchased products as illustrated in FIG. 4 to be described later. For example, in a case where the product to be recommended is clothing, the proportion of the product features among the purchased products may be the proportion of the clothing colors, the proportion of the clothing patterns, or the proportion of the clothing materials. It is estimated that the products purchased by many persons with similar facial features are products preferred by the persons with similar facial features or products that look good on the persons with similar facial features. Therefore, according to the product recommendation information including the information indicating the purchase tendencies, the intended user can recognize how well a product to be recommended matches the intended user's preference and how well it is likely to be suited to the intended user.

FIG. 4 is another example of the product recommendation information generated by the generation unit 103. In FIG. 4, the product recommendation information indicates the proportions of the purchased lipstick shades, such as “brown-toned 50%”, “orange-toned 20%”, and “pink-toned 30%”, as “purchase tendencies of persons whose faces are similar” that are information indicating purchase tendencies in history information associated with the identified other pieces of facial information. In FIG. 4, the product recommendation information includes information “XXX series No. 000” indicating a product that is a brown-toned product with high purchase tendency and is frequently included in the history information associated with the identified other pieces of facial information.

The generation unit 103 may generate the product recommendation information based on history information including a purchase history of the same products as those in the purchase history of the intended user among pieces of the history information associated with the identified other pieces of facial information. Other users having the purchase history of the same product as that in the purchase history of the intended user can be estimated to have a similar preference or purchase tendency to the intended user. Therefore, the generation unit 103 can generate the product recommendation information with higher appeal to the intended user. The generation unit 103 may generate the product recommendation information based on the history information including a purchase history of the same product.

The generation unit 103 may generate the product recommendation information based on history information in which preference information associated with other pieces of facial information is similar to the preference information of the intended user among pieces of the history information associated with the identified other pieces of facial information. Here, the preference information is information indicating preference of the user. The preference information may be information estimated from the history information, or may be information such as a questionnaire result input by the user. The preference information of other users is only required to be associated with at least the facial information, and for example, only required to be associated with the membership information associated with the facial information. The preference information of the intended user may be associated with the membership information, or may be input by an operation on the terminal device when the product recommendation is performed. The generation unit 103 may generate the product recommendation information based on history information associated with other pieces of facial information in which the preference information associated with other pieces of facial information shares equal to or more than a predetermined number of items with the preference information of the intended user. The generation unit 103 may generate the product recommendation information based on the history information associated with other pieces of facial information in which the preference information associated with other pieces of facial information shares equal to or more than a predetermined proportion of items with the preference information of the intended user. The predetermined number and the predetermined proportion are only required to appropriately determined in such a way that history information necessary for generating the product recommendation information can be identified. Thus, the generation unit 103 can generate the product recommendation information with higher appeal to the intended user.

The generation unit 103 may generate the product recommendation information indicating whether a purchase-desired product that the intended user desires to purchase matches the purchase tendency based on a purchase history included in the history information associated with other pieces of facial information. The purchase-desired product that the intended user desires to purchase is only required to be input on the terminal device by the intended user or the salesclerk who provides customer service to the intended user. In a case where the purchase-desired product that the intended user desires to purchase matches the purchase tendency based on the purchase history included in the history information associated with other pieces of facial information, the generation unit 103 may generate the product recommendation information indicating that the purchase-desired product is suitable for the intended user. In a case where the purchase-desired product that the intended user desires to purchase does not match the purchase tendency based on the purchase history included in the history information associated with other pieces of facial information, the generation unit 103 may generate the product recommendation information indicating that the purchase-desired product is not suitable for the intended user.

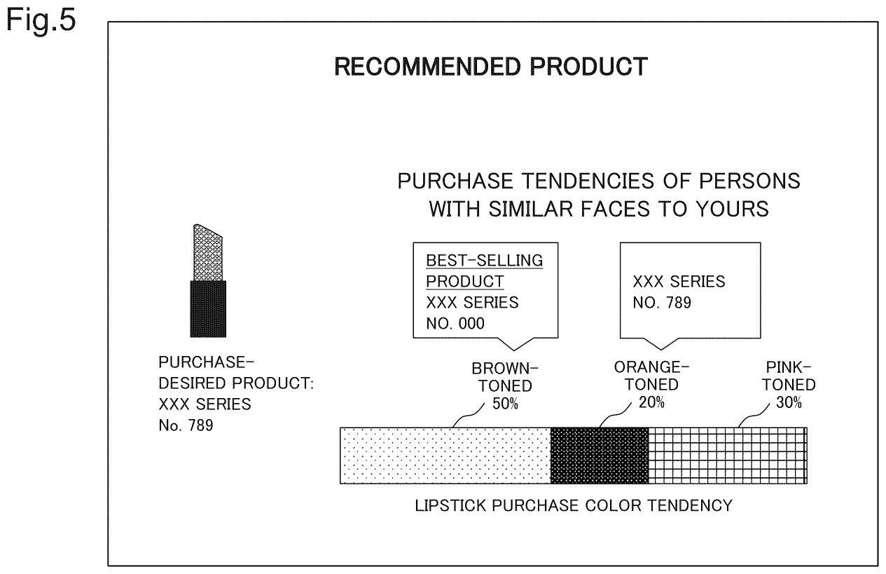

FIG. 5 is still another example of the product recommendation information generated by the generation unit 103. In FIG. 5, the product recommendation information indicates that the purchase-desired product “XXX series No. 789” has a relatively low tendency of “orange-toned 20%” in the “purchase tendencies of persons whose faces are similar”, which is information indicating the purchase tendencies in the history information associated with the identified other pieces of facial information. This is an example of the product recommendation information indicating that the purchase-desired product is not suitable for the intended user. In FIG. 5, the product recommendation information indicates the information “XXX series No. 000” indicating a product that is a brown-toned product with high purchase tendency and is frequently included in the history information associated with the identified other pieces of facial information as a “best-selling product”.

The product recommendation information may include a facial image of the intended user in a state of using the product included in the product recommendation information. Thus, the intended user can easily consider whether to purchase the product included in the product recommendation information.

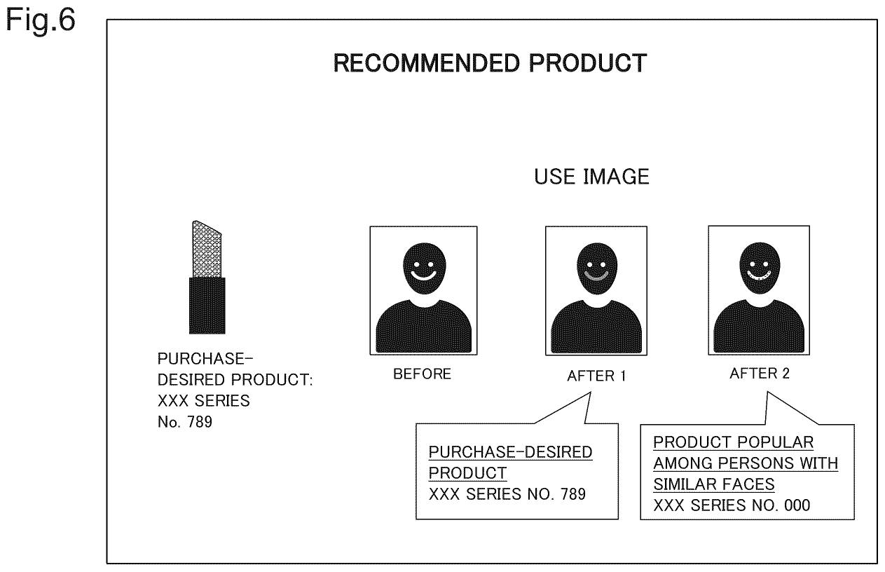

FIG. 6 is still another example of the product recommendation information generated by the generation unit 103. In FIG. 6, the product recommendation information includes a facial image “AFTER 1” of the intended user in a state of using the purchase-desired product. This is an example of the product recommendation information indicating that the purchase-desired product is not suitable for the intended user. The intended user or the salesclerk who provides customer service to the target user can recognize that the purchase-desired product is not suitable for the intended user based on the facial image of the intended user in a state of using the purchase-desired product. The facial image of the intended user in a state of using the purchase-desired product, which is the product recommendation information indicating that the purchase-desired product is not suitable for the intended user, may be indicated as being not suitable when the frame of the image or the background color of the image is changed. In FIG. 6, the product recommendation information includes, as comparison targets, an original facial image “BEFORE” of the intended user, and a facial image “AFTER 2” of the intended user in a state of using the best-selling product “XXX series No. 000”.

The generation unit 103 may generate the product recommendation information based on the purchase history of a product other than a product purchased as a gift, among the purchase histories included in history information associated with other pieces of facial information. For example, the generation unit 103 may generate the product recommendation information based on a purchase history other than a purchase history in which gift wrapping is included in the purchase history from the same transaction among the purchase histories included in the history information associated with other pieces of facial information. For example, in a case where information such as a flag indicating that the product is for a gift is associated with the product included in the purchase history, the generation unit 103 may determine that the product is a product purchased as a gift. In this case, the generation unit 103 generates the product recommendation information based on a purchase history other than the purchase history of the product in which the information such as a flag indicating that the product is for a gift is associated with the product included in the purchase history among the purchase histories included in the history information associated with other pieces of facial information. Thus, the generation unit 103 can generate the product recommendation information with higher appeal to the intended user. This is because there is a case where the products purchased as the gifts by other users are not purchased for use by themselves, and in this case, there is a possibility that the products purchased as the gift by other users are not products suitable for the faces of those users.

The content of the product recommendation information generated by the generation unit 103 described above may be combined as appropriate. For example, the product recommendation information may include a facial image in a state where the intended user uses a product and a purchase tendency. However, the combination of the content of the product recommendation information is not limited to these examples. Methods by which the generation unit 103 generates the product recommendation information may be combined as appropriate. For example, the generation unit 103 may generate the product recommendation information by using, among pieces of history information, information about a product that is included in a specific product category and is not a product purchased as a gift. However, an example of the method for generating the product recommendation information to be combined is not limited thereto.

The output unit 104 is an example of an output means for outputting the product recommendation information. The output unit 104 outputs, to the terminal device, information for displaying the product recommendation information generated by the generation unit 103 on the display unit of the terminal device. For example, the output unit 104 performs output for displaying the product recommendation information on the display unit of the terminal device installed in a store. For example, the output unit 104 performs output for displaying the product recommendation information using an application on the terminal device used by the intended user.

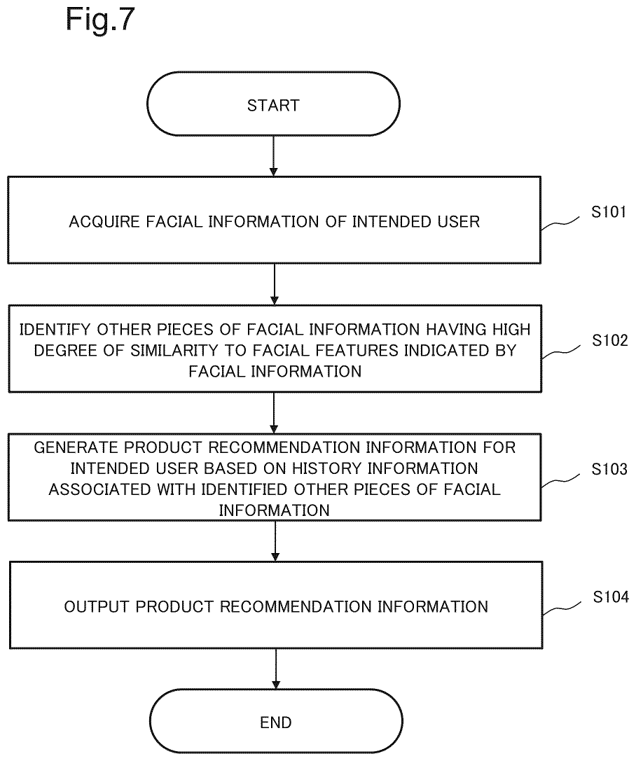

The operation of the product recommendation device 100 configured as described above will be described with reference to the flowchart of FIG. 7.

As illustrated in FIG. 7, first, the acquisition unit 101 acquires facial information indicating facial features of the intended user (step S101).

Next, the identification unit 102 identifies other pieces of facial information having a high degree of similarity to the facial features indicated in the facial information acquired in step S101 (step S102).

Next, the generation unit 103 generates product recommendation information for the intended user based on history information about purchases of products of other users associated with the other pieces of facial information identified in step S102 (step S103).

The output unit 104 outputs the product recommendation information generated in step S103 to the terminal device.

As described above, the product recommendation device 100 ends a series of operations.

In the product recommendation device 100 according to the present example embodiment described above, the identification unit 102 identifies other pieces of facial information having a high degree of similarity to the facial features indicated by the facial information of the intended user. The generation unit 103 generates the product recommendation information for the intended user based on the history information about purchases of products of other users associated with the identified other pieces of facial information. As a result, the product recommendation device 100 according to the present example embodiment can provide a technology for more easily recommending a product to a user.

In particular, the history information used by the generation unit 103 to generate the product recommendation information includes information indicating a product related to the purchase of the product. Therefore, the product can be easily recommended to the user.

Since it is estimated that a product that is frequently purchased by persons with similar facial features or a product used to provide customer service is a product that is preferred by persons with similar facial features or a product that is suitable for persons with similar facial features, the product recommendation device 100 according to the present example embodiment can recommend a product that is likely to be preferred by the user or a product that is likely to be suitable for the user.

### Modification Example

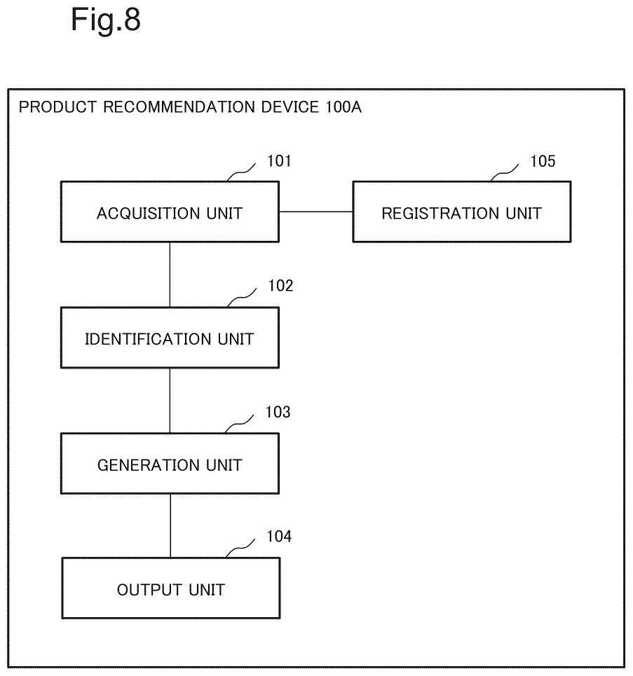

FIG. 8 is a block diagram illustrating a functional configuration of a product recommendation device 100A according to a modification example. The product recommendation device 100A includes a registration unit 105 that registers facial information acquired from the terminal device. The registration unit 105 may store the acquired facial information of the intended user in the membership information database in association with the membership information of the intended user. The registration unit 105 may perform this processing in a case where the facial information is not associated with the membership information of the intended user. Thus, in a case where the other users are the intended users for the product recommendation, the generation unit 103 of the product recommendation device 100 can generate the product recommendation information using the facial information and the history information of the registered intended user.

In a case where the facial information of the intended user is already stored in association with the membership information, the registration unit 105 may update the facial information to the facial information acquired from the terminal device. Thus, in a case where the other users are the intended users for the product recommendation, the generation unit 103 of the product recommendation device 100 can generate the product recommendation information according to the change in the facial features of the intended users who are the other users.

In a case where the facial information of the intended user is already stored in association with the membership information, the registration unit 105 may add the facial information acquired from the terminal device to the membership information together with the date and time when the facial information is acquired and store this face information. That is, the registration unit 105 stores the history of the facial information of the intended user in the membership information database. Thus, in a case where the other users are the intended users for the product recommendation, the generation unit 103 of the product recommendation device 100 can generate the product recommendation information according to the change in the facial features of the intended users who are the other users and the preference of the intended users.

### Hardware Configuration

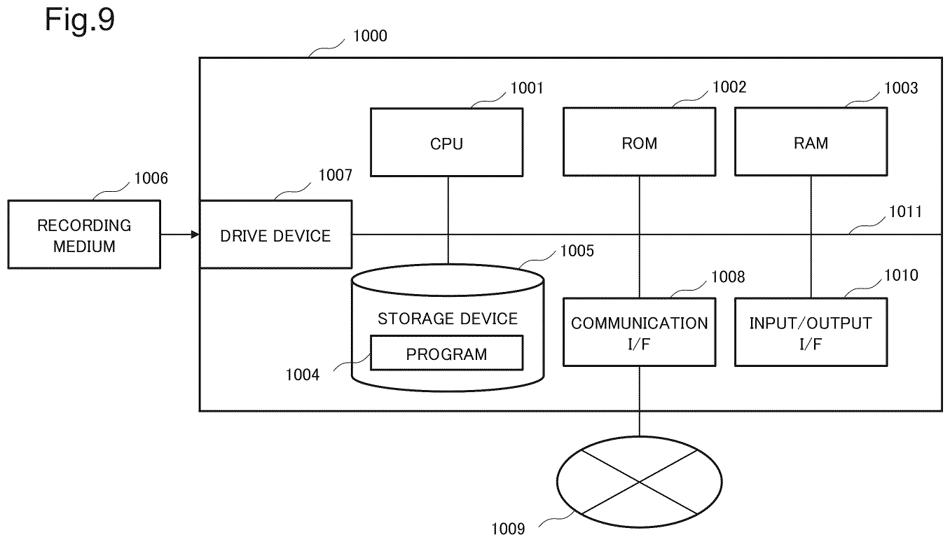

Some or all of the components of each device or system in each example embodiment of the present disclosure described above is achieved by, for example, any combination of an information processing device 1000 and a program as illustrated in FIG. 9. As an example, the information processing device 1000 includes the following configurations.
A central processing unit (CPU) 1001
A read only memory (ROM) 1002
A random access memory (RAM) 1003
A program 1004 loaded into the RAM 1003
A storage device 1005 storing the program 1004
A drive device 1007 for reading a recording medium 1006
A communication I/F 1008 connected to a communication network 1009
An input/output I/F 1010 for inputting/outputting data
A bus 1011 connecting each component I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modification examples of the method for achieving each device. For example, each device or system may be achieved by any combination of the information processing device 1000 and the program separate for each component. A plurality of components included in each device may be achieved by any combination of one information processing device 1000 and the program.

Some or all of the components of each device or system are achieved by a general-purpose or dedicated circuit including a processor or the like, or a combination thereof. The circuit is, for example, a CPU, a graphics processing unit (GPU), a field programmable gate array (FPGA), or a large scale integration (LSI) for artificial Intelligence (AI) processing. These may be configured by a single chip or may be configured by a plurality of chips connected via a bus. Some or all of the components of each device may be achieved by a combination of the above-described circuit and the like and the program.

In a case where some or all of the components of each device or system are achieved by a plurality of the information processing devices, circuits, and the like, the plurality of information processing devices, circuits, and the like may be arranged in a centralized manner or in a distributed manner. For example, the information processing devices, the circuits, and the like may be achieved as a form in which each is connected via the communication network, such as a client-server system or a cloud computing system.

Although the present invention has been described with reference to each example embodiment, the present invention is not limited to the above example embodiments. Various modifications that can be understood by those skilled in the art can be made to the configuration and details of the present invention within the scope of the present invention.

Although a plurality of operations is described in order in the form of a flowchart, the order of description does not limit the order of executing the plurality of operations. Therefore, when each example embodiment is implemented, the order of the plurality of operations may be changed within a range that does not interfere with the content.

Some or all of the above example embodiments may be described as the following supplementary notes, but are not limited to the following.

### Supplementary Note 1

A product recommendation device including:
an acquisition means for acquiring facial information indicating facial features of an intended user;
an identification means for identifying other pieces of facial information having a high degree of similarity to the facial features indicated by the facial information;
a generation means for generating product recommendation information for the intended user based on history information about purchases of products by other users associated with the identified other pieces of facial information; and
an output means for outputting the product recommendation information.

### Supplementary Note 2

The product recommendation device according to Supplementary Note 1,
in which the generation means generates the product recommendation information indicating a purchase tendency based on a purchase history included in the history information associated with the other pieces of facial information.

### Supplementary Note 3

The product recommendation device according to Supplementary Note 1 or 2,
in which the generation means generates the product recommendation information based on the history information including a purchase history of the same product as that in the purchase history of the intended user among pieces of the history information associated with the identified other pieces of facial information.

### Supplementary Note 4

The product recommendation device according to any one of Supplementary Notes 1 to 3,
in which the generation means generates the product recommendation information based on the history information in which preference information associated with the other pieces of facial information is similar to the preference information of the intended user among pieces of the history information associated with the identified other pieces of facial information.

### Supplementary Note 5

The product recommendation device according to any one of Supplementary Notes 1 to 4,
in which in a case where a purchase-desired product that the intended user desires to purchase does not match a purchase tendency based on a purchase history included in the history information associated with the other pieces of facial information, the generation means generates the product recommendation information indicating that the purchase-desired product is not suitable for the intended user.

### Supplementary Note 6

The product recommendation device according to Supplementary Note 5,
in which the product recommendation information includes a facial image of the intended user in a state of using the purchase-desired product.

### Supplementary Note 7

The product recommendation device according to Supplementary Notes 1 to 6,
in which the product recommendation information includes a facial image of the intended user in a state of using the product included in the product recommendation information.

### Supplementary Note 8

The product recommendation device according to any one of Supplementary Notes 1 to 7,
in which the generation means generates the product recommendation information based on a purchase history of the product other than a product purchased as a gift among the purchase histories included in the history information associated with the other pieces of facial information.

### Supplementary Note 9

The product recommendation device according to any one of Supplementary Notes 1 to 7,
in which the history information associated with the other pieces of facial information includes a customer service history provided by a salesclerk, and
the generation means generates the product recommendation information based on information about a product included in the customer service history.

### Supplementary Note 10

A product recommendation method including, by a computer:
acquiring facial information indicating facial features of an intended user;
identifying other pieces of facial information having a high degree of similarity to the facial features indicated by the facial information;
generating product recommendation information for the intended user based on history information about purchases of products by other users associated with the identified other pieces of facial information; and
outputting the product recommendation information.

### Supplementary Note 11

A recording medium storing a program that causes a computer to execute processing of:
acquiring facial information indicating facial features of an intended user;
identifying other pieces of facial information having a high degree of similarity to the facial features indicated by the facial information;
generating product recommendation information for the intended user based on history information about purchases of products by other users associated with the identified other pieces of facial information; and
outputting the product recommendation information.

### REFERENCE SIGNS LIST

10 database
100 product recommendation device
101 acquisition unit
102 identification unit
103 generation unit
104 output unit
100A product recommendation device
105 registration unit
1000 information processing device
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. A product recommendation device comprising:
one or more memories storing instructions; and
one or more processors configured to execute the instructions to:
acquire facial information indicating facial features of an intended user;
identify other pieces of facial information having a high degree of similarity to the facial features indicated by the facial information;
generate product recommendation information for the intended user based on history information about purchases of products by other users associated with the identified other pieces of facial information; and
output the product recommendation information.

2. The product recommendation device according to claim 1, wherein the one or more processors is configured to execute the instructions to:
generate the product recommendation information indicating a purchase tendency based on a purchase history included in the history information associated with the other pieces of facial information.

3. The product recommendation device according to claim 1, wherein the one or more processors is configured to execute the instructions to:
generate the product recommendation information based on the history information including a purchase history of a same product as that in the purchase history of the intended user among pieces of the history information associated with the identified other pieces of facial information.

4. The product recommendation device according to claim 1, wherein the one or more processors is configured to execute the instructions to:
generate the product recommendation information based on the history information in which preference information associated with the other pieces of facial information is similar to the preference information of the intended user among pieces of the history information associated with the identified other pieces of facial information.

5. The product recommendation device according to claim 1, wherein the one or more processors is configured to execute the instructions to:
in a case where a purchase-desired product that the intended user desires to purchase does not match a purchase tendency based on a purchase history included in the history information associated with the other pieces of facial information, generate the product recommendation information indicating that the purchase-desired product is not suitable for the intended user.

6. The product recommendation device according to claim 5,
wherein the product recommendation information includes a facial image of the intended user in a state of using the purchase-desired product.

7. The product recommendation device according to claim 1,
wherein the product recommendation information includes a facial image of the intended user in a state of using the product included in the product recommendation information.

8. The product recommendation device according to claim 1, wherein the one or more is processors configured to execute the instructions to:
generate the product recommendation information based on a purchase history of the product other than a product purchased as a gift among the purchase histories included in the history information associated with the other pieces of facial information.

9. The product recommendation device according to claim 1,
wherein the history information associated with the other pieces of facial information includes a customer service history provided by a salesclerk, and
wherein the one or more processors is configured to execute the instructions to:
generate the product recommendation information based on information about a product included in the customer service history.

10. A product recommendation method comprising, by a computer:
acquiring facial information indicating facial features of an intended user;
identifying other pieces of facial information having a high degree of similarity to the facial features indicated by the facial information;
generating product recommendation information for the intended user based on history information about purchases of products by other users associated with the identified other pieces of facial information; and
outputting the product recommendation information.

11. A non-transitory recording medium storing a program that causes a computer to execute processing of:
acquiring facial information indicating facial features of an intended user;
identifying other pieces of facial information having a high degree of similarity to the facial features indicated by the facial information;
generating product recommendation information for the intended user based on history information about purchases of products by other users associated with the identified other pieces of facial information; and
outputting the product recommendation information.
